(19) United States
(12) Patent Application Publication
(10) Pub. No.: US 2020/0207974 A1
(43) Pub. Date: Jul. 2, 2020

(54) THERMOPLASTIC ELASTOMER COMPOUNDS HAVING HIGH BIORENEWABLE CONTENT FOR OVERMOLDING ON NON-ELASTOMERIC POLYMER SUBSTRATES

(71) Applicant: PolyOne Corporation, Avon Lake, OH (US)

(72) Inventors: Liang XU, Vernon Hills, IL (US); Krishna VENKATASWAMY, Crystal Lake, IL (US)

(73) Assignee: PolyOne Corporation, Avon Lake, OH (US)

(21) Appl. No.: 16/622,414

(22) PCT Filed: Jun. 15, 2018
(86) PCT No.: PCT/US2018/037685

§ 371 Date: Dec. 13, 2019

Related U.S. Application Data
(60) Provisional application No. 62/520,999, filed on Jun. 16, 2017.

(51) Int. Cl. C08L 53/00; B32B 27/32; B32B 27/08; B29C 45/14; B29C 45/00

(52) U.S. Cl. CPC C08L 53/005; B32B 27/32; B32B 27/08; B29C 45/14; B33Y 70/00; C08L 2205/025; C08L 2205/035; C08L 2207/04; B29C 45/0001

(57) ABSTRACT

TPE compounds having at least 35 weight percent of bio-renewable content are disclosed as candidates for use as overmolding layers on to polypropylene substrates.

### CLAIM OF PRIORITY

This application claims priority from U.S. Provisional Patent Application Ser. No. 62/520,999 bearing Attorney Docket Number 12017012 and filed on Jun. 16, 2017, which is incorporated by reference.

### FIELD OF THE INVENTION

This invention relates to thermoplastic elastomers made from bio-based polymers for use in overmolding on to non-elastomeric polypropylene substrates.

### BACKGROUND OF THE INVENTION

The world of polymers has progressed rapidly to transform material science from wood and metals of the 19^{th} Century to the use of thermoset polymers of the mid-20^{th} Century to the use of thermoplastic polymers of later 20^{th} Century.

In the subset of elastomeric polymers, the same transformational progress has occurred as thermoplastic elastomer (TPE) has supplanted thermoset rubber. Combining the processing advantages of a thermoplastic with the performance advantages of an elastomer has promoted TPE to be ubiquitous in consumer goods, such as gripping surfaces on toothbrushes, as well as a myriad of other end uses in a variety of modern industries.

TPEs are often reliant upon a single macromolecule having blocks of hard and soft segments. The most common TPE is a styrenic block copolymer (SBC) in which, for example, there are two styrenic hard end blocks and an olefinic soft middle block. Examples of this hard-soft-hard TPE structure are styrene-butadiene-styrene (SBS) and its hydrogenated form of styrene-ethylene-butylene-styrene (SEBS).

Bio-based polymers have become commercially available. Non-limiting examples include polystyrene-polyhydrogenated farnesene-polystyrene triblock copolymer bio-based elastomers (“HSFC”) from Kuraray of Japan and polyethylene bio-based polymer (“bio-PE”) from Braskem of Brazil.

In overmolding end use applications with polyolefins, especially polypropylene (“PP”), it has been found that neither HSFC nor bio-PE alone or in combination successfully can overmold to non-elastomeric PP.

### SUMMARY OF THE INVENTION

What the art needs is a TPE compound which successfully overmolds to non-elastomeric polypropylene containing substrates, wherein the TPE compound contains at least about 35 weight percent of bio-renewable content.

The present invention solves that problem by using a combination of polymers having bio-renewable content with other ingredients can achieve successful overmolding to PP.

One aspect of the invention is a thermoplastic elastomer compound, comprising: A thermoplastic elastomer compound, comprising: (a) HSFC; (b) bio-PE; (c) SEBS; (d) PP; and (e) mineral oil, wherein the compound has a bio-renewable content of at least 35 weight percent and a 90° Peel Test on PP of greater than 10 pli.

Another aspect of the invention is a polymer article of the above compound. Another aspect is the method of forming the polymer article into its final shape, including overmolding to PP.

Features of the invention will become apparent with reference to the following embodiments.

### EMBODIMENTS OF THE INVENTION

Polymeric Ingredients

Bio-Based Polymers

Bio-Based Styrenic Block Copolymer

Polystyrene-polyhydrogenated farnesene-polystyrene triblock copolymer (“HSFC”) is the matrix of TPE useful in this invention. The bio-renewable content in HSFC is based on the hydrogenated farnesene midblock being formed from bio-based sources, such as sugar cane and corn.

Multiple grades of this HSFC, such as SF 901, SF 902, and SF 903, are available from Kuraray, differentiated at least by melt flow rate (MFR) and Shore A hardness.

Bio-Based Polyolefin

Polyethylene bio-based polymer (bio-PE) is a contributing polymer to the TPE matrix. The bio-renewable content of the bio-PE is based on the use of sugar cane as the feedstock for polymerization. Multiple grades of this bio-PP are available from Braskem, differentiated at least by MFR.

Conventional Polymers

Styrenic Block Copolymer

Styrenic block copolymers (“SBCs”) are well known thermoplastic elastomer candidates, especially SBCs which utilize styrenic end blocks and butadiene-based midblocks. Of them, hydrogenated SBS copolymers, also known as SEBS, are preferred. Within the G Series of SBCs from Kraton Polymers, G1654 and G1642 SEBS copolymers are preferred for use in this TPE compound.

Polyolefin

Polyethylenes and polypropylenes are nearly ubiquitous in polymer compounding, and the TPE compound here benefits from polypropylene in the compound to assist in compatibility of the TPE compound to a polypropylene substrate during overmolding.

Optional Additives

The compound of the present invention can include other conventional plastics additives in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (elsevier.com), can select from many different types of additives for inclusion into the compounds of the present invention.

Non-limiting examples of optional additives include adhesion promoters; biocides (antibacterials, fungicides, and mildewcides), anti-fogging agents; anti-static agents; dispersants; fillers and extenders; fire and flame retardants and smoke suppressants; hardness adjusters; initiators; lubricants; micas; mold release agents; pigments, colorants and dyes; oils and plasticizers; processing aids; release agents; silanes, titanates and zirconates; slip and anti-blocking agents; stabilizers; stearates; ultraviolet light absorbers; viscosity regulators: waxes; and combinations of them. Of these optional additives. UV absorbers, anti-oxidants, and mold release agents are often used.

Generally, minor amounts of such additives provide improvement of performance to the compound during processing with the other ingredients in the polymer resin or in performance of the polymeric molded article after manufacturing. One skilled in the art without undue experimentation can determine the appropriate concentration.

Table 1 shows the acceptable, desirable, and preferable ranges of ingredients for the compound of the present invention, all expressed in weight percent of the compound. The compound can comprise, consist essentially of, or consist of the following ingredients. Any number between the ends of the ranges is also contemplated as an end of a range, such that all possible combinations are contemplated within the possibilities of Table 1 as candidate compounds for use in this invention.

TABLE 1
Ranges of Ingredients

| Ingredient (Wt. %) | Acceptable | Desirable | Preferable |
|---|---|---|---|
| HSFC TPE | 30-80 | 40-60 | 42-48 |
| Bio-based PE | 1-30 | 5-20 | 7-17 |
| SEES | 3-40 | 5-20 | 10-15 |
| PP | 1-30 | 5-20 | 7.5-9 |
| Mineral Oil | 3-60 | 10-30 | 16-22 |
| Optional Additives | 0.05-2 | 0.1-1 | 0.6-1.0 |

Processing

The preparation of compounds of the present invention is uncomplicated. The compound of the present invention can be made in batch or continuous operations.

Mixing in a continuous process typically occurs in an extruder that is elevated to a temperature that is sufficient to melt the polymer matrix with addition at the head of the extruder. Extruder speeds can range from about 50 to about 500 revolutions per minute (rpm), and preferably from about 300 to about 500 rpm. Typically, the output from the extruder is pelletized for later extrusion or molding into polymeric articles.

Mixing in a batch process typically occurs in a Banbury mixer that is also elevated to a temperature that is sufficient to melt the polymer matrix to permit addition of the solid ingredient additives. The mixing speeds range from 60 to 1000 rpm. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (elsevier.com), one can make articles of any conceivable shape and appearance using compounds of the present invention.

Compounds for Overmolded Substrate

Any durable polymer capable of being injection molded and have less elasticity and preferably more rigidity more than the overmolding TPE layer is a candidate for use in the present invention. Also, the durable polymer can have flexibility or other type of deformability, but preferably rigid polymers are better candidates for substrates because of the considerable difference in deformability of the overmolding layer to the overmolded layer. Without undue experimentation, one having ordinary skill in the art could formulate a compound suitable for injection overmolding in a fashion to determine the adhesion peel strength of the overmolding TPE layer thereto. Of the candidates, polypropylene of various grades is preferred.

As stated previously, polar substrates, such as those containing polycarbonate, polyamide (also called nylon), are already identified as suitable substrates for TPE overmolding in making consumer electronic parts.

Overmolding Processing

Those having ordinary skill in the art of polymer processing, particularly injection overmolding processing, can recognize that the equipment for injection overmolding of an elastomeric layer to a non-elastomeric substrate of other polymers can also be applicable to TPE overmolding layers on to polymeric substrates.

Injection overmolding typically has ranges of settings as seen in Table 2, when TPE is used.

TABLE 2

| Molding Condition | PP Acceptable | PP Preferred |
|---|---|---|
| Rear Barrel Temperature, ° F. | 330-350 | 340-350 |
| Center Barrel Temperature, ° F. | 330-350 | 340-350 |
| Front Barrel Temperature, ° F. | 330-350 | 340-350 |
| Nozzle Barrel Temperature, ° F. | 330-350 | 340-350 |

Other variables for molding conditions are dependent on either the machine or the nature of the part to be molded. Without undue experimentation, a person having ordinary skill in the art can determine these variables for each combination of machine and molded part.

### USEFULNESS OF THE INVENTION

Any plastic article made by injection molding is a candidate for use of any laminate of the various overmolding layers and overmolded substrates in combination as disclosed above. Particularly useful are those plastic articles which require both sturdiness and durability from the overmolded substrate and flexibility and tactile benefits from the overmolding layer.

Articles with need for gripping by the human hand lead the likely candidates to be made from the compounds of the present invention. From hand tools to handle bars, from pill containers to ice chests, the combination of performance properties of “over” layer and “under” layer allows for the plastic article designer to utilize formulations contemplated by this disclosure.

The overmolding layer need not cover the entire overmolded substrate. Indeed, there are many situations where the properties of the overmolding layer are detrimental to the outer surface of the exposed overmolded substrate which does not require the flexibility and tactile sensations required at the surfaces of the overmolding layer. For example, one can guide the human hand to the correct location of proper leverage of a hand tool by arranging the overmolding layer to cover the overmolded substrate only at the preferred location. The same concept is also true for golf clubs, axes, exercise equipment, and the like.

Also, the polymeric article need not be only two layers of elastomeric overmolding layer and non-elastomeric, preferably rigid, overmolded substrate. Different surfaces of the substrate can be overmolded with different flexible overmolding layers to provide more versatility of specialized polymeric materials. For example, a hand tool can have one overmolding layer of one formulation where the palm contacts the tool and a second overmolding layer of a second formulation where the fingers grip the tool. If used in low-light conditions, the flexibility and tactility of the different layers can signal the orientation of the hand tool in the hand.

### USEFULNESS OF THE INVENTION

The TPE compound disclosed here can be made into any extruded, molded, spun, casted, calendered, thermoformed, or 3D-printed article. Non-limiting examples of candidate end uses for such finally-shaped TPE articles are listed in summary fashion below.

Appliances: Refrigerators, freezers, washers, dryers, toasters, blenders, vacuum cleaners, coffee makers, and mixers;

Consumer Goods: Power hand tools, rakes, shovels, lawn mowers, shoes, boots, golf clubs, fishing poles, and watercraft;

Electrical/Electronic Devices: Printers, computers, business equipment, LCD projectors, mobile phones, connectors, chip trays, circuit breakers, and plugs;

Healthcare: Wheelchairs, beds, testing equipment, analyzers, labware, ostomy, IV sets, wound care, drug delivery, inhalers, toothbrushes, safety razors, and packaging;

Industrial Products: Containers, bottles, drums, material handling, valves, and safety equipment;

Consumer Packaging: Food and beverage, cosmetic, detergents and cleaners, personal care, pharmaceutical and wellness containers;

Transportation: Automotive aftermarket parts, bumpers, window seals, instrument panels, consoles; and

Wire and Cable: Cars and trucks, airplanes, aerospace, construction, military, telecommunication, utility power, alternative energy, and electronics.

Articles with need for gripping by the human hand lead the most likely candidates to be made from the compounds of the present invention. From hand tools to handle bars, from pill containers to ice chests, the plastic article designer can utilize formulations contemplated by this disclosure for a limitless set of polymeric end use products.

### EXAMPLES

Table 3 shows the commercial source of the ingredients for all Examples 1-5, their formulations, the processing of the formulations to make extruded pellets and then to mold into sample plaques for testing. Table 4 shows the results of that testing.

Overmolding Test Preparation

For the overmolding test, the following preparations were made:

Formolene 1102KR, a 4 MFR homopolymer polypropylene from Formosa Plastics, was used to mold the polypropylene substrate. This PP is representative of a frequently used homopolymer polypropylene substrate.

A Milacron injection molding machine was used to prepare the PP substrate and prepare plaques for the measurements of adhesion.

Plaques for the measurement of adhesion were prepared by injection molding TPE materials onto cold inserted rigid Formolene 1102KR 4 MFR polypropylene substrates. The barrel temperature of the injection molding machine was set from 180° C. to 215° C. (360° F. to 420° F.) and the injection velocity from 15 mm/sec to 65 mm/sec. The condition for molding the PP substrate was barrel temperature from 190° C. to 230° C. (375° F. to 445° F.) and the injection velocity from 15 mm/sec to 65 mm/sec.

Procedure for the “90° Peel Test on PP”

The adhesion between the TPE overmolding layer and the rigid thermoplastics substrate of 4 MFR homopolymer polypropylene was measured by a “90 degree peel test” which is a modified ASTM D903 method.

This test is done on overmolded plaques with the TPE overmolding layer on top of the 4 MFR homopolymer polypropylene overmolded substrate.

A TPE strip 2.54 cm (1 inch) wide and 10.16 cm (4 inches) long was cut, and a 7.62 cm (3 inches) portion of the strip was adhered to the polypropylene substrate in an overmolded position. The remaining 2.54 cm (1 inch) portion of the strip not adhered was pulled at a 900 angle from the substrate using an Instron tensile tester operating at 10″/min (15.24 cm/min) as the pulling speed.

The substrate had been locked in its place on wheels in order to maintain the 90° angle of peel as the elastomer was being pulled. The adhesion strength, matching the peel strength, is measured by the force required to pull the elastomer strip orthogonally from the substrate to which the strip is adhered. The test result was reported as a maximum strength over 5.08 cm (2 inches) of delamination due to the pulling force. The adhesion was also categorized based on a visual observation of the failure mode, i.e., an adhesive failure if no TPE residue is left on the substrate or a cohesive failure if the failure is in TPE.

Two samples for each Example were tested, and the results averaged. The numerical results are expressed in pound-force per inch (lb_{f}/in) units, wherein each pound-force per inch equals 0.175127 Newtons per millimeter (N/mm).

TABLE 3
Example

| Ingredients (Wt. %) | 1 | 2 | 3 | 4 | 5 |
|---|---|---|---|---|---|
| SF 903 Polystyrene-polyhydrogenated farnesene-polystyrene triblock | 43.54 | 47.69 | 46.88 | 47.69 | 46.40 |
| copolymer bio-based elastomers (Kuraray) | | | | | |
| G1654 Polystyrene-polyethylene butylene-polystyrene copolymer | 13.06 | 14.31 | 10.49 | 14.31 | |
| elastomer (Kraton) | | | | | |
| G1642 Polystyrene-polyethylene butylene-polystyrene copolymer | | | | | 15.80 |
| elastomer (Kraton) | | | | | |
| Puretol PSO 380 Mineral Oil plasticizer (Petro Canada) | 19.16 | 21.94 | 16.09 | | 21.30 |
| Puretol 10 Mineral Oil plasticizer (Petro Canada) | | | | 21.94 | |
| SPB 608 Polyethylene bio-based polymer (Braskem) | 13.06 | 7.63 | 17.49 | 7.63 | 9.30 |
| Profax PD 702 Polypropylene (Lyondell Basell) | 10.45 | 7.63 | 8.40 | 7.63 | 6.50 |
| Irgafax 168 Tris(2,4-ditert-butylphenyl)phosphite antioxidant (BASF) | 0.13 | 0.14 | 0.11 | 0.14 | 0.14 |
| Irganox 1010 Pentaerythritol Tetrakis(3-(3.5-di-tert-butyl-4- | 0.08 | 0.09 | 0.06 | 0.09 | 0.08 |
| hydroxyphenyl)propionate) antioxidant (BASF) | | | | | |
| Kemamide E Ultra erucamide (PMC Biogenix) | 0.09 | 0.10 | 0.09 | 0.10 | 0.09 |
| Tinuvin 328 2-(2H-benzotriazol-2-yl)-4.6-ditertpentylphenol UV | 0.22 | 0.24 | 0.17 | 0.24 | 0.23 |
| absorber (BASF) | | | | | |
| UV 62 Butanedioic acid, dimethyl ester, polymer with 4-hydroxy- | 0.22 | 0.24 | 0.21 | 0.24 | 0.23 |
| 2,2,6,6-tetramethyl-1-piperidine-ethanol UV stabilizer (BASF) | | | | | |
| TOTAL | 100 | 100 | 100 | 100 | 100 |

| | |
|---|---|
| Mixing Equipment | Twin Screw extruder |
| Mixing Temp. | 160 C. |
| Mixing Speed | 500 ppm |
| Order of Addition of Ingredients | All together |
| Form of Product After Mixing | Pellets |

TABLE 4

| Properties and Performance Results | 1 | 2 | 3 | 4 | 5 | Unacceptable |
|---|---|---|---|---|---|---|
| Shore A Hardness (ASTM D2240, 10 s delay) | 55 | 44 | 56 | 45 | 39 | >65 |
| Specific gravity (ASTM D792) | 0.90 | 0.91 | 0.90 | 0.89 | 0.89 | |
| Tensile Strength, psi (ASTM D412, Die C) | 600 | 437 | 592 | 401 | 430 | |
| Elongation, % (ASTM D412, Die C) | 288 | 192 | 305 | 177 | 209 | <100 |
| Viscosity @ 1340.5/sec and 200 C. (ASTM D3835) | 73 | 79 | 73 | 66 | 72 | |
| Overmolding Max 90° peel on PP (pli) | 19 | 18 | 18 | 18 | 15 | <10 |
| Failure Mode: (A = adhesive) (C = cohesive) | A | A | A | A | A | |
| Calculated bio renewable content (%) | 43 | 41 | 50 | 41 | 41 | <35 |

All five Examples were successfully formulated and prepared to serve as overmolding layers on to a polypropylene substrate. As test results indicated, the 90° peel adhesion was well in excess of 10 pli (1.75127 Newtons per millimeter (N/mm)).

The 90° Peel Test on PP can be greater than about 12, desirably at least 15, and can range from about 16 to about 20 and preferably from about 18 to about 19.

The percent Elongation can range from about 170 to about 310 and preferably from about 200 to about 300.

The Shore A Hardness can range from about 40 to about 60 and preferably from about 45 to about 55.

For those markets seeking to have bio-renewal content in overmolding thermoplastic elastomers laminated to overmolded non-elastomeric thermoplastic polymers, the percent bio-renewable content can range from about 40 to about 50 and preferably from about 41 to about 45.

The invention is not limited to the above embodiments. The claims follow.

1. A thermoplastic elastomer compound, comprising:
(a) HSFC
(b) bio-PE
(c) SEBS
(d) PP
(e) mineral oil,
wherein the compound has a bio-renewable content of at least 35 weight percent and a 90° Peel Test on PP of greater than 10 pli.

2. The compound of claim 1, wherein the HSFC is bio-renewable content from sources comprising sugar cane or corn and wherein the bio-PE is bio-renewable content from sources comprising sugar cane.

3. The compound of claim 1, wherein the compound further optional additives selected from the group consisting of adhesion promoters; biocides; anti-fogging agents; anti-static agents; dispersants; fillers and extenders; fire and flame retardants and smoke suppressants; hardness adjusters; initiators; lubricants; micas; mold release agents; colorants; plasticizers; processing aids; release agents; silanes, titanates; zirconates; slip agents; anti-blocking agents; stabilizers; stearates; ultraviolet light absorbers; viscosity regulators; waxes; and combinations of them.

4. The compound of claim 3, wherein the optional additives comprise UV absorbers, anti-oxidants, mold release agents, or combinations thereof.

5. The compound of claim 3, wherein the weight percent ranges of ingredients are

| | |
|---|---|
| HSFC TPE | 30-80 |
| Bio-based PE | 1-30 |
| SEBS | 3-40 |
| PP | 1-30 |
| Mineral Oil | 3-60 |
| Optional Additives | 0.05-2. |

6. The compound of claim 4, wherein the weight percent ranges of ingredients are

| | |
|---|---|
| HSFC TPE | 40-60 |
| Bio-based PE | 5-20 |
| SEBS | 5-20 |
| PP | 5-20 |
| Mineral Oil | 10-30 |
| Optional Additives | 0.1-1. |

7. The compound of claim 3, wherein the weight percent ranges of ingredients are

| | |
|---|---|
| HSFC TPE | 42-48 |
| Bio-based PE | 7-17 |
| SEBS | 10-15 |
| PP | 7.5-9 |
| Mineral Oil | 16-22 |
| Optional Additives | 0.6-1.0. |

8. The compound of claim 4, wherein the weight percent ranges of ingredients are

| | |
|---|---|
| HSFC TPE | 42-48 |
| Bio-based PE | 7-17 |
| SEBS | 10-15 |
| PP | 7.5-9 |
| Mineral Oil | 16-22 |
| Optional Additives | 0.6-1.0. |

9. The compound of claim 1, wherein the Shore A Hardness is less than 65, wherein the percent Elongation is less than 100, and wherein the 90° Peel Test on PP is at least about 15.

10. A polymeric article, comprising a compound of claim 1.

11. The polymeric article of claim 10, wherein the article is in final molded, extruded, thermoformed, calendered, spun, casted, or 3D-printed shape.

12. The polymeric article of claim 10, wherein the compound is an overmolding layer and where the polymeric article also comprises a thermoplastic overmolded layer, wherein the overmolding layer is two-component molded onto the overmolded layer.

13. The polymeric article of claim 12, one overmolding layer of the compound is one formulation and wherein a second overmolding layer of the compound is a second formulation and wherein both overmolding layers are two-component molded to the overmolded layer.

14. The polymeric article of claim 12, wherein each overmolding layer provides a gripping surface for a human hand.

15. A method of using the compound of claim 1 to form a polymer article, wherein the method comprises the step of shaping the compound to form the article, wherein shaping is selected from the group consisting of molding, extrusion, thermoforming, calendering, spinning, casting, or 3D-printing.
